(19) United States
(12) Patent Application Publication
(10) Pub. No.: US 2025/0192543 A1
(43) Pub. Date: Jun. 12, 2025

(54) METHOD FOR OPERATING AN ELECTRONIC CIRCUIT BREAKER, ELECTRONIC CIRCUIT BREAKER, AND ELECTRIC SYSTEM COMPRISING AN ELECTRONIC CIRCUIT BREAKER

(71) Applicant: Siemens Aktiengesellschaft, München (DE)

(72) Inventor: Marvin Tannhäuser, Hausen (DE)

(21) Appl. No.: 18/840,664

(22) PCT Filed: Jan. 31, 2023
(86) PCT No.: PCT/EP2023/052297

§ 371 Date: Aug. 22, 2024

(30) Foreign Application Priority Data
Feb. 25, 2022 (DE) 10 2022 201 962.8

(51) Int. Cl. H02H 7/22

(52) U.S. Cl. CPC H02H 7/228

(57) ABSTRACT

A method for operating a circuit breaker which couples a load circuit to be protected to a supply circuit is provided. The load circuit is deactivated by the electronic switch element. Current measurement values separated by a time interval are then ascertained for the current flowing through the circuit breaker. At least two voltage values separated by a time interval are ascertained for the voltage being applied to the supply-side terminals of the circuit breaker, at least one voltage value thereof being ascertained after the deactivation. The current circuit is reactivated by the electronic switch element, wherein the duration between the deactivation and the reactivation is selected such that a load supplied by the load circuit is not damaged by interrupting the power supply. The impedance of a supply line of the supply circuit is calculated from the voltage values and the current measurement values as and the time interval thereof.

### CROSS-REFERENCE TO RELATED APPLICATIONS

This application is a national stage of PCT Application No. PCT/EP2023/052297, having a filing date of Jan. 31, 2023, which claims priority to DE Application No. 10 2022 201 962.8, having a filing date of Feb. 25, 2022, the entire contents both of which are hereby incorporated by reference.

### FIELD OF TECHNOLOGY

The following relates to a method for operating an electronic circuit breaker, to an electronic circuit breaker, and to an electrical system comprising an electronic circuit breaker.

### BACKGROUND

Modern semiconductor circuit breakers (SCCB for short, sometimes also solid state circuit breakers, SSCB for short; in the following text, the abbreviation SCCB is used) are capable of switching off electrical circuits in the event of a short circuit, much more quickly than conventional circuit breakers (miniature circuit breakers, MCB for short). In this case, SCCBs also have a rated switching capacity or short circuit switching capacity. This involves the current value at which an MCB or an SCCB can still switch off safely in the event of a short circuit. In 230/400 V domestic installations, this current value is between 3 kA and 15 kA, for example. Energy supply companies in Germany require a short circuit switching capacity of at least 6 kA.

As generally known, the short circuit switching current or the rated switching capacity is a multiple of the rated current of the MCB or SCCB. Conventional rated currents in consumer circuits in the case of 230/400 V domestic installations are 10 A, 16 A, or 32 A, for example.

### SUMMARY

An aspect relates to a method by which the maximum short circuit current actually to be expected can be determined or at least estimated.

One advantage of the invention can be seen in the fact that a circuit breaker according to the invention, in particular a semiconductor circuit breaker SCCB, determines current and voltage measurement values for calculating or in any case estimating a line impedance of the supply line of the supply circuit, by virtue of the circuit breaker interrupting the supply of the load circuit for just long enough to record a sufficient number of measurement values without this interruption damaging the load. This takes advantage of the fact that loads designed in accordance with the relevant standards tolerate brief interruptions without this leading to the load malfunctioning. The interruption lasts no longer than 20 ms, no longer than 10 ms, but can also be limited to 2 ms.

The calculation of the line impedance is carried out by processing units which are already present in modern SCCBs. Alternatively, the measurement values are transmitted to a parent device for evaluation.

Components which are already present in modern circuit breakers, in particular in SCCBs, such as the electronic switching element that switches quickly in comparison with the mechanical switching element, the one or more voltage measuring means and the one or more current measuring the SCCB, are used here, that is to say except for the control means or processing units, which can be produced in software or firmware, for example, no adjustments need to be made to the SCCB.

The determined line impedance can be displayed to an operator or installer, who can then compare it with a setpoint value and take appropriate measures in the event of intolerable deviations. The display can take place here by a display unit of the SCCB itself and/or by a display on a device that is coupled wirelessly or by wire to the SCCB. This can be a permanently installed device of the electrical system, for example, or a portable device, for example a portable diagnostic device or a smartphone.

From the determined or estimated value for the line impedance, the operator or installer can determine the maximum short circuit current to be expected. In exemplary embodiments, this step can be part of the automated method according to the invention, by virtue of the SCCB and/or the parent device determining, from the line impedance, a maximum current increase to be expected in the event of a short circuit in the load circuit, which maximum current increase is displayed to the operator or installer instead of and/or in addition to the line impedance.

If, in the event of a short circuit in the load circuit, the maximum current increase to be expected exceeds the short circuit switching capacity of the SCCB or a threshold value derived therefrom, for example 80% of the short circuit switching capacity, the SCCB can be put into a safety mode, for example switched off, and an appropriate error message can be output to the operator or installer.

In the following text, exemplary embodiments of the present invention will be explained in more detail with reference to drawings.

### BRIEF DESCRIPTION

Some of the embodiments will be described in detail, with references to the following Figures, wherein like designations denote like members, wherein:

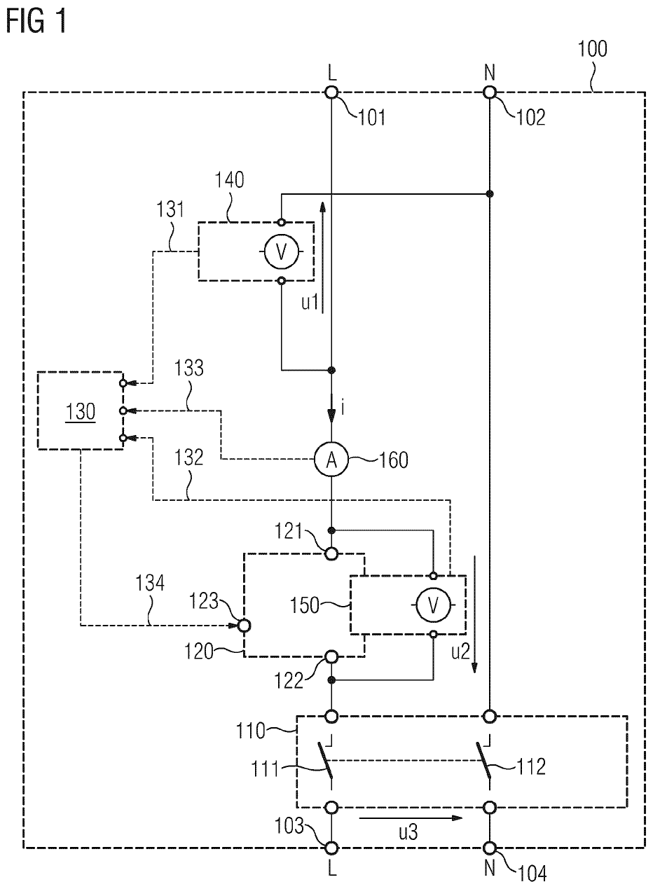

FIG. 1 shows a basic circuit diagram of a circuit breaker according to an exemplary embodiment of the present invention;

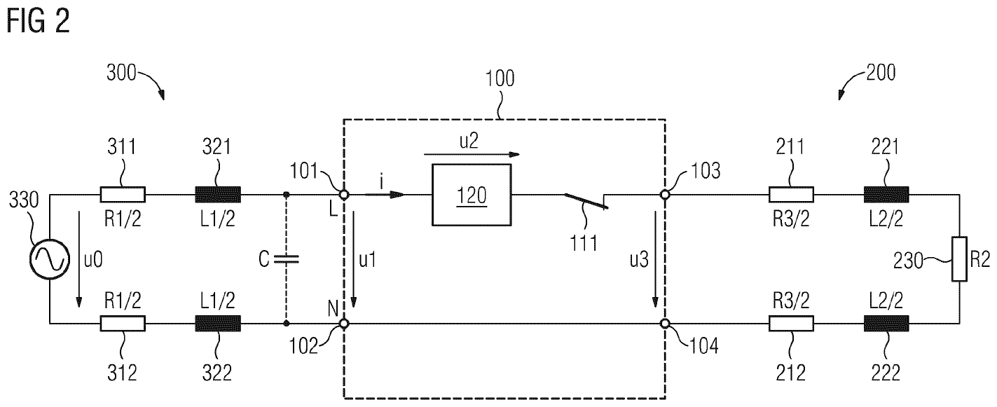

FIG. 2 shows an equivalent circuit diagram for a circuit comprising a circuit breaker according to an exemplary embodiment of the present invention;

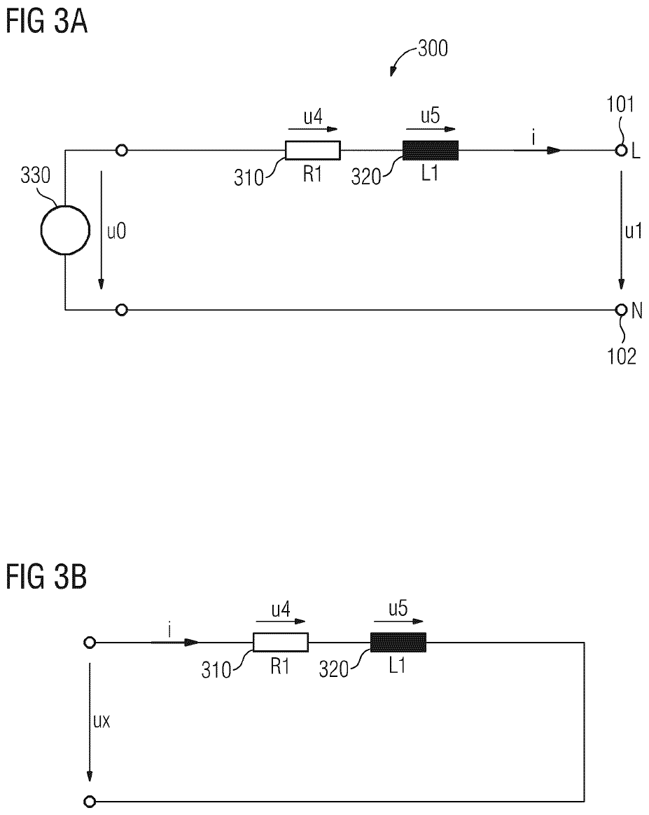

FIG. 3A shows a simplified equivalent circuit diagram of the supply side of the circuit according to FIG. 2;

FIG. 3B shows a further simplification of FIG. 3A;

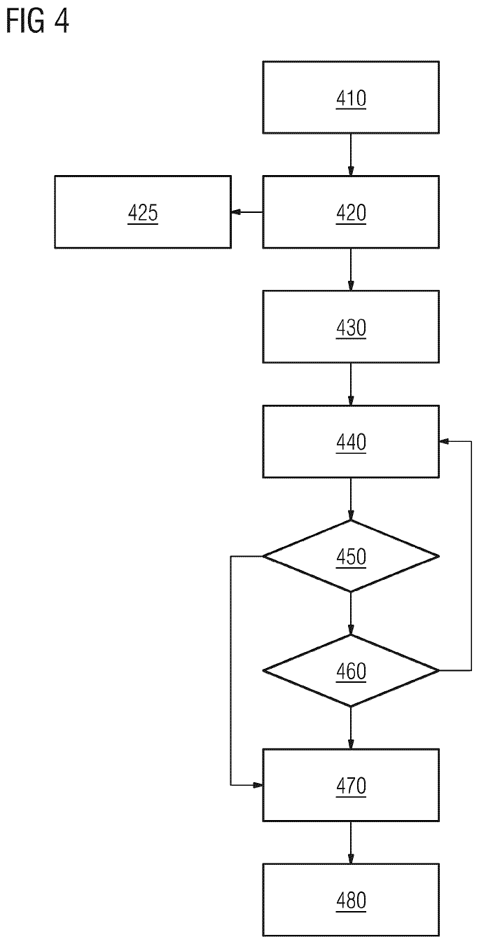

FIG. 4 shows a simplified flow diagram of an exemplary embodiment of the method; and

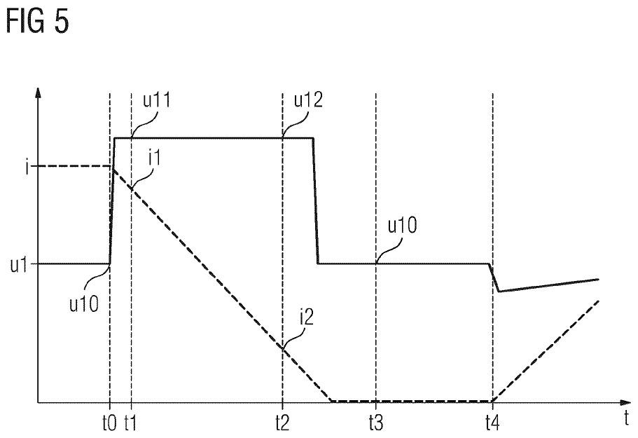

FIG. 5 shows an exemplary progression of current and voltage in a circuit breaker during performance of an exemplary embodiment of the method.

### DETAILED DESCRIPTION

FIG. 1 shows a basic circuit diagram of a circuit breaker 100, in particular of a semiconductor circuit breaker SCCB, according to an exemplary embodiment of the present invention. The SCCB 100 has main- or supply-side terminals 101 and 102 and load-side terminals 103 and 104. In this case, without loss of generality, the N conductor of the exemplary AC system extends between the terminals 102 and 104 and the L conductor extends between the terminals 101 and 103.

The SCCB 100 has at least one mechanical switching contact. In the example depicted, the SCCB 100 has two mechanical switching contacts 111, 112, which can galvanically separate the input terminals 101, 102 from the output terminals 103, 104 for both conductor paths L and N. In the example depicted, the two switching contacts 111, 112 are coupled and combined to form a two-pole mechanical disconnector 110.

In addition to the (electro) mechanical switching element 110, the SCCB 100 has an electronic switching element or a power semiconductor element 120, which is arranged in the L conductor path and has a main-side pole 121, a load-side pole 122 and a control input 123.

Via the control input 123, the electronic switching element 120 is controlled by a control element 130 via a signal line 134, in particular switched on and off as a function of an operating state predefined by the control element 130. The control element 130 can be a microcontroller, for example. In exemplary embodiments of the invention, it can additionally be envisioned that the microcontroller 130 also controls the mechanical switching element 110 (not depicted). In other exemplary embodiments, it can be envisioned that the mechanical switching element 110 is controlled by a separate, electronic or electromechanical control element (not depicted), which in turn can be coupled to the control element 130.

The control element 130 receives signals or measurement values from sensors or measurement apparatuses of the SCCB 100, and this is indicated by arrows 131, 132, 133 in the depiction in FIG. 1. For the sake of a better overview, the depiction of any necessary signal conversions was dispensed with, since the relevant person skilled in the conventional art is familiar with appropriate mechanisms.

In the exemplary embodiment depicted, the SCCB 100 has means 140 for determining the (AC) voltage u1 applied to the main-side terminals 101, 102, by which means a value representing the time-dependent voltage u1 is delivered to the control element 130 via the link 131.

Furthermore, the SCCB 100 has means 150 for determining the voltage u2 dropping across the electronic switching element 120. By these means, a value representing the time-dependent voltage u2 is delivered to the control element 130 via the link 132. In an exemplary embodiment, a time-dependent voltage u3 at the output terminals 103, 104 can be determined by the control element 130 by simple signed addition or subtraction from the values for u1 and u2. Expressed in the form of an equation, the following applies for the depicted exemplary embodiment: u3=u1−u2.

In other exemplary embodiments, the voltage u3 can be determined directly by appropriate measurement means arranged at the output terminals (not depicted), it being possible then to dispense with the means 140 or 150, depending on the case.

The exemplary SCCB 100 finally has means 160 for determining the current i flowing through the SCCB 100, which means are arranged in the conductor path L switched by the power semiconductor 120. The means 160 deliver a value representing the time-dependent current i to the control element 130 via the link 133.

The remaining functionality of the controller 130 will be explained in more detail further below in conjunction with FIG. 4 and FIG. 5.

FIG. 2 shows a greatly simplified equivalent circuit comprising a consumer circuit or load circuit 200 that is connected to a supply circuit 300 by an SCCB 100. The depiction of the SCCB 100 has also been greatly simplified and reduced to the depiction of the main-side terminals 101, 102, the load-side terminals 103, 104 and the switching means 120, 111 in the L path. For the sake of a better overview, the already mentioned voltages u1, u2 and u3 and the current i are also depicted. In addition, the main voltage u0 is depicted.

Starting from the load-side L terminal 103 of the SCCB 100, the consumer circuit 200 has the following elements: a first ohmic line component 211 with the value R3/2, a first inductive line component 221 with the value L2/2, a load 230 with the value R2, a second inductive line component 222 with the value L2/2 and a second ohmic line component 212 with the value R3/2.

The supply circuit 300 has a main-side voltage source 330, which feeds the assembly shown in FIG. 2 via a supply line. In the L path, the supply line has a first ohmic line component 311 with the value R1/2 and a first inductive line component 321 with the value L1/2. The N path has a second inductive line component 322 with the value L1/2 and a second ohmic line component 312 with the value R1/2.

Looking at a further simplification (cf. FIG. 3), for the sake of simplicity it has already been assumed here that the ohmic components 311, 312 and the inductive components 321, 322 are each approximately identical for the forward and return lines in the supply circuit 300, and thus each correspond to approximately half of the entire line resistance R1 and the entire line inductance L1 between the main-side terminals 101, 102 of the SCCB 100 and the main-side voltage source 330.

A further simplified equivalent circuit diagram of the supply circuit 300 between the main-side terminals 101, 102 of the SCCB 100 and the source 330 is shown in FIG. 3A. The ohmic and inductive line components 311, 312, 321, 322 shown in FIG. 2 have been combined to form an ohmic line component 310 with the value R1 and an inductive line component 320 with the value L1. Thus, for the purposes of further inspection, the ohmic line component R1, the inductive line component L1 and the source 330 form the simplified supply circuit 300 through which the current i flows. The source 330 delivers the time-dependent voltage u0, while the time-dependent voltage u1 is applied to the main-side terminals 101, 102 of the SCCB 100. The time-dependent voltages u4 and u5 drop across the components R1 and L1. Expressed in the form of an equation, this gives:

$$u 0 = u 4 + u 5 + u 1.$$

For the further inspection, the simplified equivalent circuit diagram from FIG. 3A has been further simplified again, FIG. 3B.

The voltages u0 and u1 have been combined here to form ux, wherein the following applies: ux=u0−u1 and ux=u4+u5.

An advantageous configuration of embodiments of the method according to the invention will be explained hereinbelow with reference to FIG. 4. In embodiments, the method starts in step 410, for example in response to a request generated by an operator, if the following requirements are met: the electronic switching element 120 of the SCCB 100 is switched on and the mechanical switching element 110 is closed, i.e., the consumer circuit 200 is switched on and there is no fault (e.g., short circuit or overload) in the consumer circuit 200.

In step 420, embodiments of the method waits until the time-dependent current i reaches a minimum value, since the higher the current at the point in time of the intended switching off (cf. step 430), the better embodiments of the method work. For example, the current i can be measured across a plurality of cycles of the input AC voltage, in order to determine the present maximum flowing current, and embodiments of the method moves on to step 430 if at least 80% of the maximum current is flowing. If no current is presently flowing, for example because there is no active load at the consumer circuit, and/or the peak value of the current is below a definable threshold, for example below 1A, embodiments of the method is terminated, step 425, and an appropriate (error) message is output to the operator. The operator can be requested, for example, to connect a minimum load to the consumer circuit, and to subsequently restart embodiments of the method.

In exemplary embodiments, in particular if an (estimated) value for the line impedance is not required quickly, but instead it is possible to wait for a suitably high current, embodiments of the method pauses in step 420 until such a current-related event occurs, for example a switching-on procedure (inrush) of a capacitive load. In addition or as an alternative, in step 420 an operator can be requested to connect or (briefly) activate such a load.

If a sufficiently high current value was achieved in step 420, the electronic switching element 120 of the SCCB is switched off in step 430. Looking at FIG. 5, this is the point in time t0.

In step 440 (at the point in time t1 in FIG. 5), a current value i1 of the current i flowing in the supply circuit 300 is determined and simultaneously, or at least approximately simultaneously, a voltage value u11 of the voltage u1 applied at the input side to the SCCB 100 is determined. These values u11 and i1 are stored in a storage device (not depicted). For the SCCB 100 depicted in the example in FIG. 1, the respective present values for u1 and i at the point in time t1 are determined by the measurement apparatuses explained further above in conjunction with FIG. 1.

In configurations of the present invention, the recording of u1 and i can also take place at different points in time. This is useful, for example, if the SCCB 100 has one (single) voltage measuring means that is initially connected to the lines L and N, in order to determine a present value for u1, and subsequently to the terminals of a measurement resistor or shunt (not depicted) that is integrated into the path L, in order to determine the voltage drop across this measurement resistor, and from this the controller 130 then calculates a present value for the current i, for example.

In step 450, a check is made as to whether the time period since the electronic switching element 120 of the SCCB was switched off in step 430 is still below a configurable maximum time period tmax. This configurable time period is selected such that it is smaller than or the same as a time for brief supply interruptions that is to be tolerated by loads which are constructed in accordance with standards, thus for example tmax=20 ms, tmax=10 ms, in specific configurations also tmax=2 ms. If the abovementioned condition is not met, i.e., the time period since switching off is greater than tmax, embodiments of the method is continued with step 470. If the abovementioned condition is met, i.e., the time period since switching off is smaller than or the same as tmax, embodiments of the method is continued with step 460.

As an alternative to checking in step 450 whether the time period since the electronic switching element 120 of the SCCB was switched off in step 430 is still below the configurable maximum time period tmax, can also

In step 460, a check is made as to whether a predefinable number of values for u1 and i was determined. In exemplary embodiments, here the minimum number of values is 2 values for i and one value for u1, respectively. In further exemplary embodiments, for example, 3, 4, 5, 6, 7, or 8 values can be used in particular for i, but also for u1. The following generally applies: the higher the processing speed of the control unit, the more values can be recorded, which subsequently makes it possible, in the calculation step 470, to have a plausibility check of the values and/or filtering such as smoothing and/or interpolations at certain points in time and/or to fade out transient processes.

In exemplary embodiments of the invention, instead of the check in step 450 as to whether the time period since the electronic switching element 120 of the SCCB was switched off in step 430 is still below the configurable maximum time period tmax, the predefinable number of values for i and the measurement interval can be selected such that the product of number and measurement interval is smaller than tmax. For example, in the case of tmax=10 ms, up to 9 measurement values can be recorded at a measurement interval of 1 ms without having to fear that tmax will be exceeded, taking a safety margin into account.

If the predefinable number of values has not yet been reached, embodiments of the method jumps back to step 440 and a new determination of present values for i and optionally for u1 is carried out. This is indicated by way of example in FIG. 5: at the point in time t2, a value i2 is determined as described further above for i1. A further value u12 is optionally also determined for u1.

In exemplary embodiments of the invention, for the sake of simplicity it is assumed that u1 changes immediately after the switching off and then remains constant, while the current i decreases. Based on this simplifying assumption, it may be sufficient to determine only one value for u1, as long as the current i has not yet dropped to zero. It is possible, but not necessary, to determine this value at the same time as one of the current measurements.

If the predefinable number of value pairs is reached and/or the maximum time tmax for switching off the electronic switching element 120 is reached, the repetition is terminated, and embodiments of the method is continued with step 470.

In step 470, the electronic switching element 120 of the SCCB 100 is switched on if this is not prevented by processes running in parallel for safety reasons, for instance because in the meantime a short circuit in the consumer circuit 200 has been detected. Looking at FIG. 5, the switching on of the electronic switching element 120 takes place at the point in time t4.

For the calculations described further below, one more measurement value for u1 is required that allows a conclusion to be drawn regarding the main voltage u0 (see FIG. 3A). If a short or very short time segment (microseconds to a maximum of a few milliseconds) is observed immediately before the switching off in step 430, a quasi-stationary state can be assumed, i.e., u0 and i are regarded as constant, u5 is close to zero (since i is constant). R1 is assumed to be small and u4 is therefore regarded as negligible, such that directly before the switching off in step 430, u1 ˜ u0 applies. This means that a voltage measurement value u10, which corresponds approximately to the main voltage u0, can thus be determined shortly before the switching off in step 430, for example as a sub-step of step 430, before the switching off takes place.

Alternatively, u10 can be determined if, after the switching off, the stationary state is achieved that is characterized by i=0, see FIG. 5 for example at the point in time t3. A better approximate value for u0 can be determined here, since because i=0 also u4=0. However, it is possible that the current i does not drop to zero within tmax, and therefore there is no point in time t3 at which i=0 applies.

In exemplary embodiments, the procedure can therefore be as follows: in step 430, before the switching off, initially a value for u1 is measured that is then stored as an approximate value u10 for u0. In embodiments, the method is then carried out with the steps 430, 440, 450, 460 and in one of the steps a check is made as to whether the current i has dropped to zero without tmax having been reached. As soon as i=0 has been reached, or shortly thereafter, a new measurement of u1 is carried out and used as the new value for u10 instead of the previously determined approximate value, as a basis for the remainder of embodiments of the method. Expressed another way, before the switching off, an approximate value for u10 is determined, which is then used if the current does not drop to zero, and which is replaced by a better measurement value if the current drops to zero within tmax.

Subsequently, in step 470, the line impedance L1 of the supply cable or main cable between the circuit breaker 100 and the (notional) main voltage source 330, voltage values u10, u11 or u12 (or the average value from u11 and u12 and further voltage values) and the current measurement values i1, i2 and the time interval between them Δt=t2−t1 is at least approximately calculated. For this purpose, in exemplary embodiments, initially Δi=i2−i1 and ux=u11−u10 are calculated. Then, based on the simplifying equivalent circuit diagram according to FIG. 3B, an approximate value for di/dt is determined by the relationship di/dt=Δi/At and finally the desired approximate value for L is determined by the relationship L1=ux/(di/dt). The voltage dropping across R1 is again regarded as negligible here.

Expressed by the values i1, i2 and the values u10 and u11 determined by multiple, in this case two, performances of the step 440, the following equation is produced for the exemplary embodiment:

$$L 1 = ( u 11 - u 10 ) / ( ( i 2 - i 1 ) / ( t 2 - t 1 ) )$$

By L1 and the peak value u0, max of the main voltage, the maximum current increase to be expected can then be determined in the event of a short circuit on the load side:

$$di / dt = u 0 , max / L 1$$

From this current increase di/dt, it is now possible to determine the maximum current that is reached before the SCCB switches off safely. To do this, all that is required is to multiply the constant dt, SCCB that is already known for the respective SCCB type by the current increase di/dt. Expressed in the form of an equation:

$$i max = di / dt * dt , SCCB$$

Expressed using the value determined for L1, the following is produced:

$$i max = u 0 , max / L 1 * dt , SCCB$$

The constant dt, SCCB is composed of the time that the SCCB requires to detect a short circuit (and to distinguish this from a switching-on procedure, for example) and the time required to subsequently switch off the semiconductor switch 120, and is typically around 0.2 to 2 microseconds.

This calculation can also be carried out by the SCCB and/or the parent device and be displayed qualitatively (for example as a colored display in red/green after comparison with a limit value, determined by a standard or some other way, such as the short circuit switching capacity, mentioned in the introduction, of 6 kA, for example) and/or quantitatively to an operator.

After calculation and output or provision of the parameters L1 and/or di/dt and/or imax, embodiments of the method ends with the step 480. It is of course possible to restart embodiments of the method in response to a corresponding operator input. In exemplary embodiments, it is possible to allow embodiments of the method to proceed automatically multiple times in succession and to perform an averaging before output of the parameters, in order to achieve a better estimation.

In some embodiments, the described method can be expanded or modified in order to detect capacitances C in the supply network (cf. FIG. 2). Looking at FIG. 5, the decrease in the current i after the switching off at the point in time to will take place significantly more gradually in the presence of a capacitance C, i.e., the term resulting from two measurement values for i:

((i2−i1)/(t2−t1))

will be significantly greater in magnitude than that caused by the (usually very low) line inductances L1. In the calculation step 470, optionally a check can be made as to whether this term exceeds a threshold value, for example a maximum value to be expected for supply lines that have a maximum length and a maximum inductance per unit length, in step 470 it can be decided that a calculation of L1 is not possible. This is signaled to the operator or provided to the operator for signaling, possibly together with a notice that there are capacitances in the supply circuit 300. The operator can then investigate to see if these capacitances are desired or undesired.

As already explained, in modified versions of embodiments of the method described above it is of course possible to improve the reliability of the estimation using further value pairs. The estimation is based, amongst other things, on the assumption that, in the very short time intervals observed, the decrease in the current i runs linearly after switching off at to and the voltage u0 does not change or in any case does not change significantly in this time (therefore that the AC system 100, 200, 300 is quasi-stationary, i.e., can be regarded as a DC voltage system with the acceptance of minor errors). The evaluation of further measurement values for i and/or u1 then makes it possible to exclude from the consideration measurement values in which the abovementioned prerequisites turn out to be irrelevant by comparison with the other value pairs or interpolation, for example in the case of transient processes or faults coupled into the line.

As already mentioned, it is possible to have the above-described method performed in full using a controller 130, for example a microcontroller, of a modern SCCB 100 and to transmit the results to a display device of the operator via a wireless or wired interface. The display device can be a mobile device, such as a smartphone for example, which can be coupled to the SCCB 100 by Bluetooth or another near-field communication technology, for example. The software running on this mobile device can be configured here in such a way that the operator only ever initiates embodiments of the method by a user input, which is then transmitted to the SCCB 100. Alternatively, it can be envisioned that the SCCB 100 only transmits the measurement values and the mobile device performs the calculations.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for operating an electronic circuit breaker that couples a load circuit to be protected to a supply circuit and has a mechanical switching element and an electronic switching element connected in series therewith, the method comprising:
a) switching off the load circuit by the electronic switching element;
b) recording at least two temporally spaced-apart current measurement values for a current flowing through the circuit breaker after the switching off;
c) recording at least two temporally spaced-apart voltage values of a voltage applied to the supply-side terminals of the circuit breaker, at least one of which after the switching off;
d) switching the load circuit on again by the electronic switching element, wherein a time period between the switching off and the switching on again is selected such that a load supplied by the load circuit is not damaged by an interruption of the current supply; and
e) calculating a line impedance of a supply line of the supply circuit and/or calculating a value for a maximum current increase to be expected in the event of a short circuit in the load circuit from the voltage values and the current measurement values and the time interval therebetween.

2. The method as claimed in claim 1, wherein
f) the circuit breaker is put into a safety mode if the line impedance undershoots a threshold value and/or the maximum current increase to be expected in the event of a short circuit in the load circuit exceeds a short circuit switching capacity of the circuit breaker or a threshold value derived from the short circuit switching capacity.

3. The method as claimed in claim 1, wherein
g) it is determined from the voltage values and the current measurement values whether the supply circuit has a capacitive component.

4. The method as claimed in claim 1, wherein
the steps b) and c) are performed simultaneously or approximately simultaneously and in each case pairs of current measurement values and voltage values are recorded.

5. The method as claimed in claim 1, wherein
some or all of the calculation steps e), f) and/or g) are carried out by means of the electronic circuit breaker.

6. The method as claimed in claim 1, wherein some or all of the calculation steps e, f) and/or g) are carried out by a parent device, wherein the current measurement values and/or voltage values required for the respective calculation are transmitted wirelessly or by wire from the circuit breaker to the parent device.

7. The method as claimed in claim 1, wherein the switching off takes place if the present value of the current flowing through the circuit breaker exceeds a threshold value, corresponds to a peak value of the current.

8. The method as claimed in claim 1, wherein one of the determined voltage values is a present value of the voltage applied to the supply-side terminals of the circuit breaker at the point in time of the switching off.

9. The method as claimed in claim 1, wherein the switching off takes place during a switching-on procedure of a load with a high switch-on current.

10. The method as claimed in claim 1, wherein the switching on again takes place no later than 20 ms, no later than 10 ms, or no later than 2 ms after the switching off.

11. An electronic circuit breaker having voltage measuring means, current measuring means and a processing unit that is programmed to perform the method as claimed in claim 1.

12. An electrical system comprising one or more circuit breakers as claimed in claim 11 and a device, which can be connected wirelessly or by wire to the circuit breaker or the circuit breakers, for determining and/or displaying the maximum current increase to be expected in the event of a short circuit in the load circuit.

13. The electrical system as claimed in claim 12, which is configured in such a way that the method for determining the maximum current increase to be expected in the event of the short circuit in the load circuit is initiated by the device.
